(19) United States
(12) Patent Application Publication
(10) Pub. No.: US 2021/0387510 A1
(43) Pub. Date: Dec. 16, 2021

(54) Interior Window Sunshade Configurations

(71) Applicant: Rohan Vishnubhai Patel, Bensalem, PA (US)

(72) Inventor: Rohan Vishnubhai Patel, Bensalem, PA (US)

(21) Appl. No.: 17/019,436

(22) Filed: Sep. 14, 2020

Related U.S. Application Data
(60) Provisional application No. 63/037,665, filed on Jun. 11, 2020.

(51) Int. Cl. B60J 1/20

(52) U.S. Cl. CPC B60J 1/2077; B60J 1/2047

(57) ABSTRACT

Disclosed is improved interior sunshade that can be used inside a window of a building and/or can be configured to be used with an automobile window. By adding easy-flex-arch and bypass bend features with a fabric hinge that is up to 15 inches wider; a sunshade can be configured to fit multiple dimensions of windows.

### CROSS-REFERENCE TO RELATED APPLICATIONS

This application is continuation-in-part of non-provisional application Ser. No. 15/715,775 filed on Sep. 26, 2017 which claims the benefit of U.S. Provisional Application No. 62/376,708 filed on Aug. 18, 2016, and U.S. Provisional Application No. 62/530,999 filed on Jul. 11, 2017, which is incorporated by reference herein. This application claims benefit of non-provisional application Ser. No. 16/208,425 filed on 3 Dec. 2018. This application also claims priority of provisional application 63/037,665 filed on 11 Jun. 2020.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

### Field of the Invention

The present invention relates to car sunshades with a support loop member sewed on a fabric wherein the fabric part inside the fabric stays erect which provides support to the fabric to stay in place against the window. The fitment of a sunshade can be improved by adding a few features to provide additional flexibility to the flexible loop member that can fit various dimensions of an automobile windows and/or window of a building and provide optimum coverage possible. The common issue the present configuration has is not enough support for a fabric to stay in place around the corners of an automobile window. The current invention also solves the issue of the flexible member hitting the rear view mirror during an installation in an automobile window.

### BRIEF SUMMARY OF THE INVENTION

It should be understood that this disclosure is not limited to the particular systems, and methodologies described herein, as there can be multiple possible embodiments of the present disclosure which are not expressly illustrated in the present disclosure. It is also to be understood that the terminology used in the description is for the purpose of describing the particular versions or embodiments only, and is not intended to limit the scope of the present disclosure.

The present invention is directed to providing an improved sunshade fitment by having a various shaped support loop member that provides optimum coverage to a window. The shapes of the flexible member can be configured to provide maximum flexibility of the flexible-member. The added flexibility of a loop member in the sunshades assures proper fitment in various sizes of automobile windows. With added flexibility of a loop member over all sizes can be reduced without compromising the fitment of a car sunshade. This sunshade configuration also can be used to provide shading for household windows.

### BRIEF DESCRIPTION OF THE DRAWINGS

For a complete understanding of the present invention, reference is now made to the following descriptions taken in conjunction with the accompanying drawing, in which:

FIG. 1 illustrates a sunshade with two loop members sewed on a same fabric.

FIG. 2 illustrates a sunshade with a loop member sewed on one rectangular fabric.

FIG. 3 illustrates substantially rectangular loop member which can be used in making of the sunshade configurations illustrated in FIG. 1 and FIG. 2. The flexible member in FIG. 3 has all four sides arched between each of two adjacent corners.

FIG. 4 illustrates substantially rectangular loop member which can be used in making of the sunshade configurations illustrated in FIG. 1 and FIG. 2. The flexible member in FIG. 4 has a bypass-bend which allows the sunshade to be installed hassle-free to a vehicle with a windshield mounted rear view mirror.

FIG. 5 illustrates a loop member configuration to be used with sunshade configurations illustrated in FIG. 1 and FIG. 2. The flexible member illustrated in FIG. 5 has two rounded corner rectangular shaped loop member with inner two corners being con-joined as one big round corner sewed on a rectangular fabric. The three sides (top, bottom and outer side) of the rounded corner rectangular shaped loop member are slightly arched outward to provide more vertical and horizontal automobile window flexibility. The forth side of the rectangular loop member is shaped as a half round and/or oval which provides easy installation because of the shape of the flexible member to bypass the flexible member from possibly hitting a rear view mirror during installation of the sunshade in the automobile.

FIG. 6 illustrates a loop member configuration to be used with sunshade configurations illustrated in FIG. 1 and FIG. 2. The flexible member illustrated in FIG. 6 has three rounded cornered rectangular shape with forth corner shaped to bypass a rear view mirror of an automobile. All four sides of the flexible member are slightly arched outward to provide more vertical and horizontal automobile window flexibility.

FIG. 7 illustrates a flexible wire being to make a loop member illustrated in FIG. 1 and FIG. 2 sunshade configurations. FIG. 7 illustrates a loop member that is pre-bent prior to making a loop member by clamping its two ends.

FIG. 8 illustrates a size guidance method based on predetermined expanded coverage and overlapped coverage of sunshade configurations shown in FIG. 1 and FIG. 2 wherein the compatibility guidance method is based on the minimum and maximum width of the two loop members. The compatibility guidance method is for recommending a sunshade compatibility based on a height of the flexible member similar to the height of the window it is being recommended for.

FIG. 9 illustrates another embodiment of a size-chart wherein the compatibility information of a sunshade is provided to the customer.

FIG. 10 illustrates another embodiment of a size-chart wherein the size-chart has a different configuration and provides information about compatible sunshade for vehicles listed.

FIG. 11 illustrates a sunshade with a configuration shown in FIG. 1 and FIG. 2 installed in a vehicle, wherein the height of the two loop members is identical to a height of the windshield window of an automobile.

FIG. 12 illustrates a sunshade with a border less sunshade with a loop member having an easy-flex-arch and bypass-bend. The sunshade shown in FIG. 12 also can be conjoined in the middle with a fabric-hinge while each of the flexible member having no border on outer, top and bottom sides.

FIG. 13 illustrates a sunshade 100 installed inside a building window.

FIG. 14 illustrates zig-zag clamping mechanism to form a loop member.

FIG. 15 illustrates clamping mechanism after forming of a zig-zag clamping.

FIG. 16 illustrates set up prior to zig-zag clamping mechanism.

FIG. 17 illustrates zig-zag clamping mechanism with opposite pressing points offset to one another.

### DETAILED DESCRIPTION OF THE INVENTION

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples. Every loop member mentioned here is made from a flexible material. Every loop member configurations are configurable with all possible sunshade configurations shown in this application. The sizing guidance method also is applicable to every possible configuration of a sunshade.

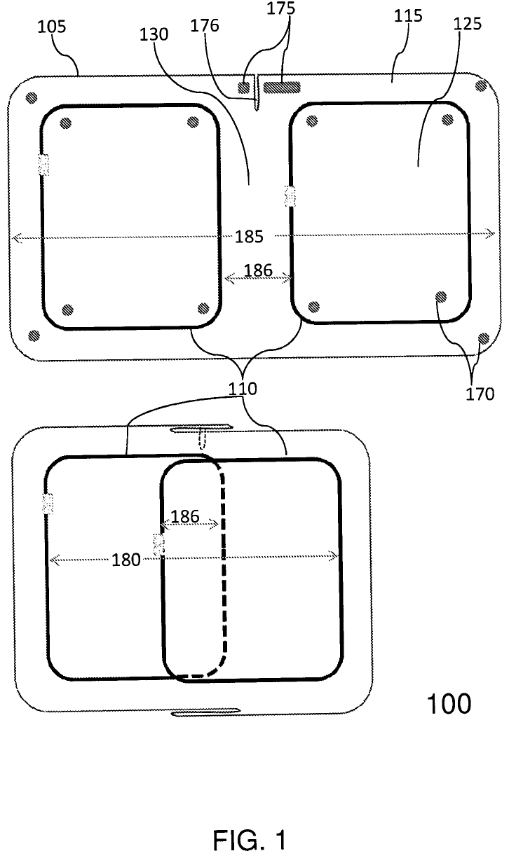

As shown in FIG. 1, a sunshade configuration 100 is formed by sewing two loop members 110 on a fabric 105. Each of the flexible members are conjoined together with one another with a fabric-hinge 130. The fabric-hinge 130 can be the same fabric 105 which holds to two sewed loop members on itself. Each of the two loop members 110 has an additional fabric border 115 outside on top, bottom and outer sides. This additional fabric is a loose fabric border 115 which helps provide coverage to uneven surfaces surrounding of the window. The fabric inside each of the flexible members 110 stays erected because of the support from the flexible members it's being sewed to. Additionally, the sunshade configuration 100 can have a securing mechanism 170 which helps secure the sunshade configuration 100 to a window. The securing mechanism 170 can be a Velcro tape, magnetic tape, a suction cup or anything that helps the sunshade configuration 100 secure to a window. The sunshade configuration 100 can be comprised of a reflective insulating material to block the sun's rays or can have a fabric that partially blocks the sunlight and/or visibility. The fabric can be having a lighter or silver color on the one side and darker color on the inside. Additionally, the fabric-hinge 130 has a cut-out 176 in the top middle to provide passage for a rear view mirror of an automotive window. Additionally the cut-out 176 has a securing mechanism 175 that helps secure the fabric around cut-out 176 to the window or to one-another. The securing mechanism 175 can be a Velcro-tape, magnetic mechanism, a suction cup or any other mechanism that serves the purpose of holding the fabric around the cut-out 176 to the glass or to secure the fabric corners to one-another. The width of the fabric-hinge is illustrated on top portion of the FIG. 1 as 186. The two loop members 110 shown in the sunshade configuration 100 can be of various shapes and sizes as illustrated in all the figures.

The sunshade configuration 100 is shown fully extended on the top of FIG. 1; wherein the total width of the coverage area 185 is a total width of the fabric with the fabric-hinge being 186 wide. The bottom part of the FIG. 1 illustrates the same sunshade configuration wherein both the flexible members 110 are overlapped with a minimum possible width shown as 180. The minimum possible width is a distance between two loop members' outer side edges (instead of outer side loose fabric border of each of the two loop members 110). The amount of overlapping of the two loop members is illustrated on the bottom portion of the FIG. 1 as 186. The overlapping of both the flexible member is similar to the width 186 of the fabric hinge between them. The bottom part of FIG. 1 illustrates minimum width possible by overlapping of both the flexible member as 180.

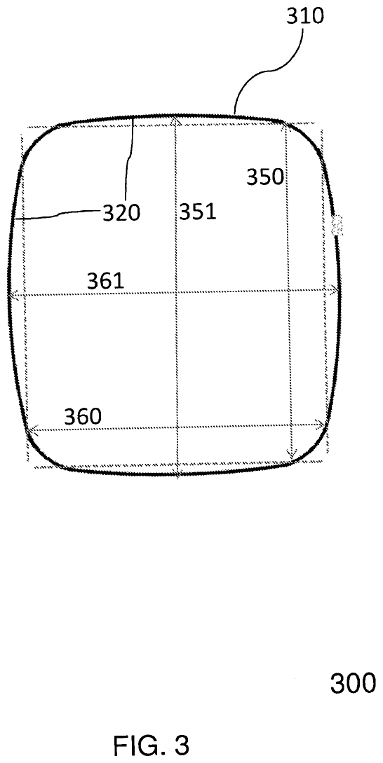

The maximum coverage width 185 and minimum width possible 180 by fully overlapping of both the flexible members can be used to provide compatibility information to a given window. A guidance method can be established wherein the compatibility is based on the fully extension of the sunshade configuration 100, partial or full overlapping of both the flexible members. This compatibility method can help recommend sunshade configuration 100 to a variety of widths of window dimensions or widths. The sunshade configuration 100 can adopt any of the flexible member shape or configuration shown FIGS. 3 to 7, FIG. 10 and FIG. 11. The sunshade 100 configuration can have a size recommendation based on wherein the both loop members' (with fabric) dimensions being similar to adoptable to the dimensions of a window. In recommendation of the sunshade configuration 100 for an automobile, one loop member can accommodate driver-side windshield and another loop member can accommodate passenger side windshield window.

The sunshade configuration 100 is shown fully extended on the top of FIG. 1; wherein the total width of the coverage area 185 is a total width of the fabric with having fabric-hinge that is 186 wide. The bottom part of the FIG. 1 illustrates the same sunshade configuration wherein both the flexible members 110 are overlapped with a minimum possible width shown as 186. The amount of overlapping of the two loop members is illustrated on the bottom portion of the FIG. 1 as 181. The overlapping portion width 181 is substantially directly related to the width of the fabric-hinge 186. The bottom part of FIG. 1 illustrates minimum width possible by overlapping of both the flexible member as 180.

The maximum coverage width 185 and minimum width possible 180 by fully overlapping of both the flexible members can be used to provide compatibility information to a given window. A guidance method can be established wherein the compatibility is based on the fully extension of the sunshade configuration 100, partial or full overlapping of both the flexible members. This compatibility method can help recommend sunshade configuration 100 to a variety of widths of window dimensions or widths.

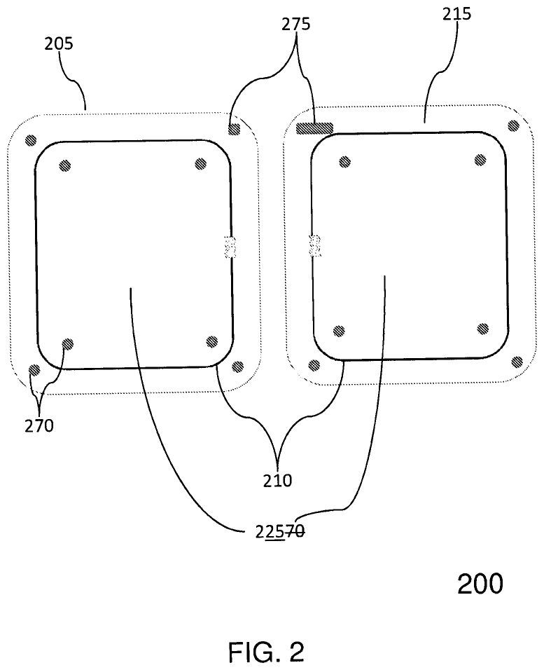

As shown in FIG. 2, a configuration of a sunshade 200 is formed by sewing two loop members 210 on separate fabrics 205. Each of the flexible members is separate from one another in this sunshade configuration 200. Each piece of the sunshade configuration 200 has one loop member 210 sewed on a fabric 205. The flexible member is surrounded by a loose fabric border 215 on all four sides in this sunshade configuration 200. This loose fabric border 215 helps block the uneven surfaces surrounding the flexible member in order to provide better blockage. The fabric border 215 can also be the same fabric 205 which holds the one sewed loop members on itself. The inside fabric 225 in both the flexible member (looped) structures stays erected because of the support from the flexible members its being sewed to. The flexible member (looped) structure helps keeping the fabric inside it to stay erected. Additionally this sunshade configuration 200 can have a securing mechanism 270 which helps secure the sunshade to a window. The securing mechanism can be a Velcro tape, magnetic tape, a suction cup or anything that helps the sunshade configuration 200 secure to a window. The sunshade configuration 200 can be comprised of a reflective insulating material to block the sun's rays. Additionally, each of the two pieces has a securing mechanism 275 that helps secure the fabric to the window or to one-another. The securing mechanism 275 can be a Velcro-tape, magnetic mechanism, a suction cup or any other mechanism that serves the purpose of holding the one sunshade piece to the glass or to the another piece of the sunshade. The two loop members 210 shown in the sunshade configuration 200 can be of various shapes and sizes as illustrated in all the figures. The sunshade configuration 200 can adopt any of the flexible member shape or configuration shown FIGS. 3 to 7, FIG. 10 and FIG. 11.

FIG. 3 illustrates a loop member 310 configuration which can be used in the sunshade configurations 100 and/or 200. In this embodiment the flexible member 310 has four easy-flex-arch sides wherein the easy-flex-arch is side that is arched between two adjacent corners of the flexible member 310. This arched side provides additional flexibility thus the shade can fit more dimensions of windows. The flexible member 310 has a height 351 when it is not under any force. When the flexible member is placed against a window slightly smaller, the flexible member allows its top and bottom loop member to accommodate and will have a squeezed height marked as 350 in the FIG. 3. The flexible member 310 has a width of 361 when it's not under any force. If a loop member is placed against a window that is narrower then the easy-flex-arches on two vertical sides will accommodate and will have squeezed width of 360. This configuration of a loop member can be used in the sunshade configuration 100 wherein two loop member are conjoined with a fabric-hinge wherein each of the flexible members 310 can accommodate height with its one or both easy-flex-arches (top and bottom horizontal sides) from 1 inch to as much as 16 inches (deviation of 0.5-8 inches for each of the two easy-flex-arches). The sunshade configuration 100 also allows use of the fabric-hinge to overlap both the flexible members; with an addition of width accommodation from 4 vertical easy-flex-arches (two per loop member). This width accommodation can allow the flexible member to shrink or expand as much as 1 inch to 10 inches for each of the two loop members. Additionally the fabric-hinge also allows width accommodation by extending both the flexible members 310 to widest possible from one another to give maximum width 185 (shown in FIG. 1) of the sunshade configuration 100 with loop members 310 to be as wide as width of the fabric both the flexible members 310 are sewed upon. The fabric-hinge also provides both the flexible member to overlap and squeeze on top of the easy-flex-arches and fit narrower windows and have width of 180 as shown in FIG. 1.

The flexible member 310 also can be used to make sunshade configuration 200 wherein one loop member is sewed on one fabric. Two piece of sunshade can be used for an automotive windshield wherein one piece will provide coverage to the driver side windshield window and other piece to the passenger side windshield window. The sunshade configuration 100 and/or 200 also can be used to make a sunshade for a building window. The flexible member 310 also can be used for a building window by having one or more loop members 310 sewed on the same fabric 305. The arched side can deviate as much as from 0.5″ to 18 inches from a straight line between two corners.

The flexible member 310 also can be used to make sunshade configuration 200 wherein one loop member is sewed on one fabric. Two piece of sunshade can be used for an automotive windshield wherein one piece will provide coverage to the driver side windshield window and other piece to the passenger side windshield window. The sunshade configuration 100 and/or 200 also can be used to make a sunshade for a building window. The flexible member 310 also can be used for a building window by having one or more loop members 310 sewed on the same fabric 305. The arched side can deviate as much as from 0.5″ to 18 inches from a straight line between two corners.

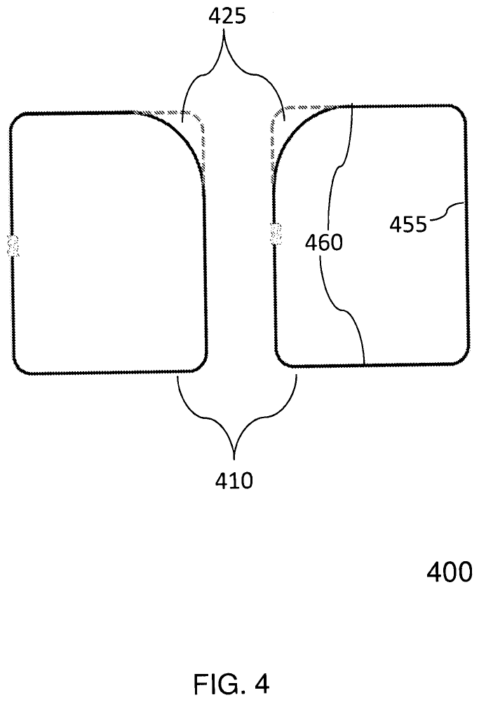

FIG. 4 illustrates another embodiment 400 of a loop member 410 that can be used with any of the two sunshade configurations 100 and/or 200. The flexible member has four substantially straight sides 455, 460 with a bypass-bent 425 in one corner which is basically a bent that help bypass obstructions on the windshield windows of an automobile. The flexible member 410 can have one to all four sides having an easy-flex-arch (not shown) to provide better compatibility to variety of windows.

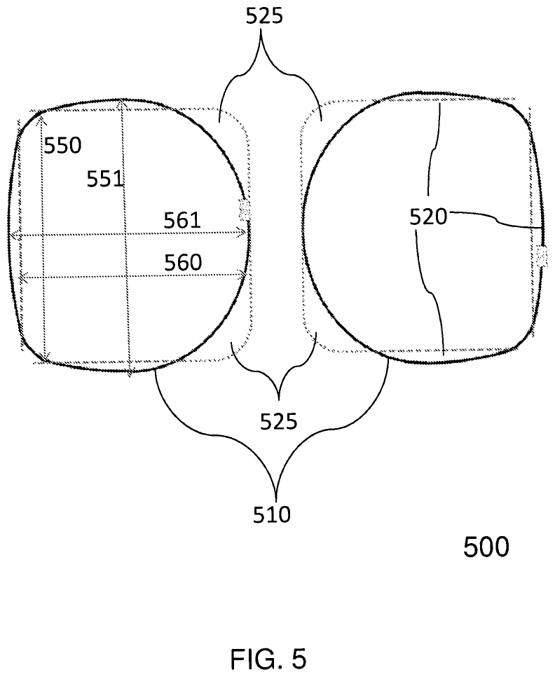

FIG. 5 illustrates two loop members' configuration 510 which can be used with sunshade configuration 100 and/or 200. In this embodiment of the flexible member 510, the flexible member has a substantially rectangular shape with one and more sides featuring easy-flex-arch 520. The flexible member can have top bottom and/or outer side/s with an easy-flex-arch 520. The flexible member 510 has outer two corners forms substantially rectangular shape. The flexible member 510 has one large oval/arched shape that replaces two inner corners of the flexible member 310 in FIG. 3. Together it forms a shape of alphabet “D” and horizontal flipped image of alphabet “D”. Alphabet “D” can be used to cover the left (driver) half of the windshield glass while a horizontal flipped shape of alphabet “D” can used to cover the right (passenger) half of the windshield glass. Additionally, the flexible member 510 has as many as three easy-flex-arches 520 to allow vertical as well as horizontal flexibility. Additionally, the flexible member 510 has a bypass-bend 525 to allow hassle free installation of the sunshade configurations 100 and/or 200 inside a vehicle without possibility of hitting a rear view mirror of the vehicle. The flexible member 510 used in the sunshade configuration 200 will have a separate rectangular fabric pieces 205 wherein each of the fabric 205 has only one loop member 510 sewed. Additionally, a securing mechanism 275 from sunshade configuration 200 also can be implemented while using loop members 510 in sunshade configuration 200. Additionally, the compatibility of the sunshade 500 recommended for windows that are about 2 inches taller than the height 551 of the flexible member 510 to 2 inches shorter than the squeezed height 550 of the flexible member 510. The compatibility of the sunshade 500 recommended for windows that are about 2 inches wider than the width 561 of the flexible member 510 to 2 inches narrower than the squeezed width 560 of the flexible member 510. The compatibility of the sunshade 500 can be recommended for windows with dimensions similar to the width of the fabric upon which the flexible member 510 (total width 185 for sunshade configuration 100) to as narrow as overlapped minimum width for 180 when if available easy-flex-arches are squeezed to adopt narrow windows for sunshade configuration 100. The same recommendation can be made for sunshade configuration wherein the maximum overlapping of the two separate sunshade pieces possible for given automobile wherein the minimum width is with squeezed easy-flex-arch 520 in the vertical outer side of each of the two loop members.

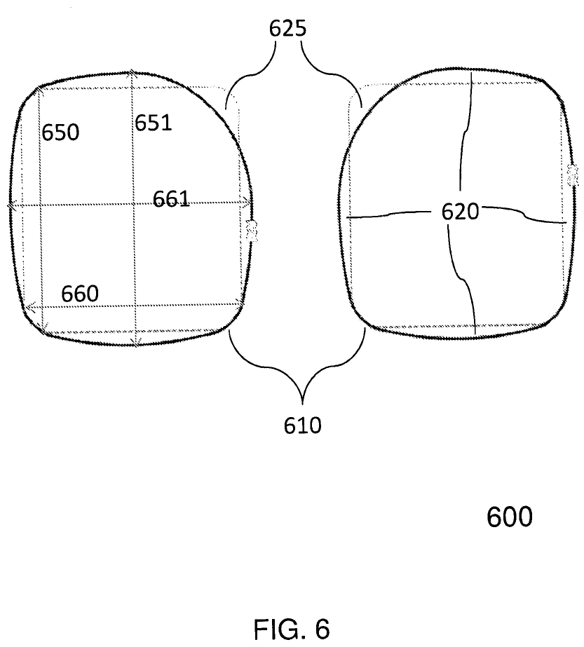

FIG. 6 illustrates two loop members' configuration 610 which can be used with sunshade configuration 100 and/or 200. In this embodiment of the flexible member 610, the flexible member has a substantially rectangular shape with one and more sides featuring easy-flex-arch 620. One of the four corners of each of the flexible members 610 has a bypass-bend which helps in bypassing the obstacle such as a rear view mirror in the middle of the windshield and/or windshield mounted forward camera. Additionally, the compatibility of the sunshade 600 recommended for windows that are about 2 inches taller than the height 651 of the flexible member 610 to 2 inches shorter than the squeezed height 650 of the flexible member 610. The compatibility of the sunshade 600 recommended for windows that are about 2 inches wider than the width 661 of the flexible member 610 to 2 inches narrower than the squeezed width 660 of the flexible member 610.

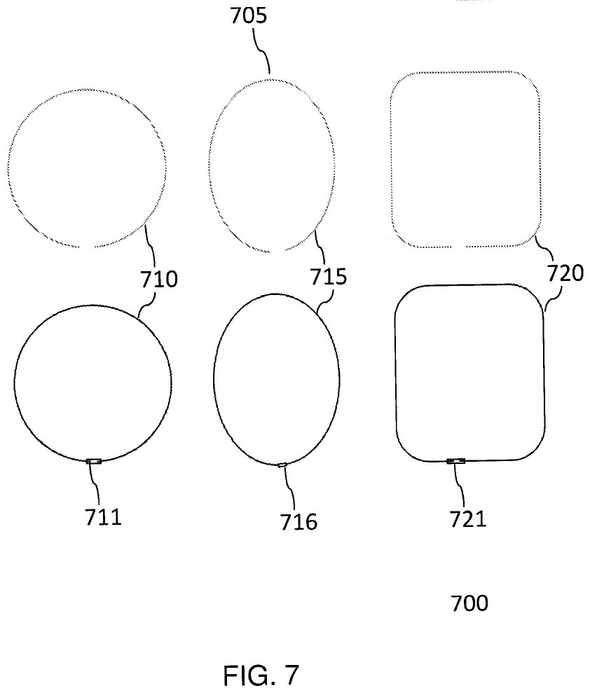

FIG. 7 illustrates a process of making loop members of various shapes for maximum flexibility. In this method a loop member wire is pre-bent prior to clamping two ends. This pre-shaped loop member is then sewed to a fabric to make a sunshade. Pre-bent wire provides maximum coverage and flexibility possibly to adopt fitment to the vehicles with similar shaped and/or dimension windows. The pre-shaped loop member also can be used to make a sunshade for a house or any other window wherein a substantially rectangular shaped loop member is sewed on a fabric. Pre-bent loop member provides better fitment appearance due to loop member having a naturally bent to match the shape desired prior to clamping of two open ends of the straight strip. As shown in FIG. 7, 705 is a substantially straight stripe from which a loop member is made by clamping two ends of the substantially straight strip. Shape 710 is formed by bending of the substantially straight strip 705. Another shape 715 is formed by bending a substantially straight loop member 705 into an oval shape 715. Another shape 720 is formed by bending substantially straight loop member 705 in to substantially rectangular shape. The shape can be of any kind to insure best fitment possible. This method of pre-bending metal loop member provides better overall fitment. Once pre-bend to the desired shape; two ends of each of the shapes 710, 715 and 720 is crimped using clamps 711; 716 and 721 respectively which then is sewed upon a fabric to form one of the sunshade 100 or 200 configurations. The process will results in a pre-bend portion of the flexible loop member prior to making a loop with a clamp which in pre-bend portion will help provide better quality coverage. This process will help pre-bend a portion of the flexible members prior to clamping for an improved fitment. The sunshade made from pre-bend portion of a loop member can be used in making a loop member for sunshade for an automobile window and/or a window of a building.

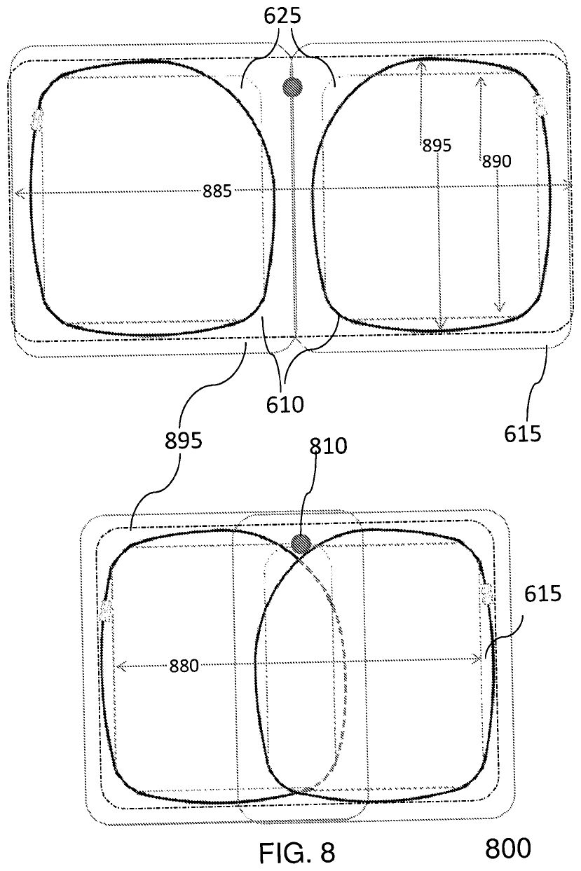

FIG. 8 illustrates a sunshade configuration 800 with each of the two loop members of embodiment shown in the FIG. 6. Each of the two loop member 610 sewed on a substantially rectangular fabric 205 placed against an interior window 896. Each of the two loop members 610 is substantially rectangular in shape with top inner corner with a bypass-bend 625 (marked with a dotted line) which would have hit the rear view mirror mount 810 if overlapped as shown in the bottom portion of the FIG. 8. Additionally each of the flexible members 610 in sunshade 800 can have as many as four easy-flex-arches; wherein each side of each of the two loop member is arched outward to provide additional flexibility. The sunshade configuration 800 has additional loose fabric border 615 surrounding to each of the two flexible loop members 610 and an easy-flex-arch 620 on the outer vertical side of each of the two flexible loop members 610. In this sunshade configuration 800, the top portion of FIG. 8 shows each of the two sunshade pieces providing converge to a windshield with a width of 885 wherein the combined width of both the sunshade pieces 885 needs to be substantially similar to the width of the windshield of the vehicle its being recommended for. On the bottom part of the sunshade configuration 800, both the sunshade pieces are overlapped until each of the flexible members top inner corner hits the rear view mirror. A minimum width of sunshade 800 is a width achieved by squeezing all easy-flex-arches present on the vertical sides of both the sunshade pieces while overlapping each of the sunshade pieces until their bypass-bend hits the rear view mirror which is marked as 880. A vertical dashed line is where the two outer vertical easy-flex-arches of each of the sunshade pieces will be when squeezed horizontally. A guidance method that uses minimum width with overlapping until the loop members hits the obstruction such as a rear view mirror with two sunshade pieces' outer sides' easy-flex-arches squeezed can be implemented to provide compatibility of the sunshade configurations 200 that can employ different loop members shown in FIGS. 3, 5, 6, and 8. The compatibility recommendation can also be for windshields with a minimum height of 3 inches smaller than the two dotted horizontal lines that illustrate easy-flex-arch squeeze-ability 890 to maximum height that of 3 inches of the height of the relaxed horizontal easy-flex-arches of each of the two loop members illustrated as 895.

The sunshade configuration 200 with two loop members 610 is shown fully extended on the top of FIG. 8; wherein the total width of the coverage area 885 is a combined width of fabric including the outer side loose fabric borders. The bottom part of the FIG. 8 illustrates the same sunshade configuration wherein both the flexible members 110 are overlapped with a minimum possible width shown as 180. The minimum possible width is a distance between two loop members' outer side edges (instead of outer side loose fabric border of each of the two loop members 110). The amount of overlapping of the two loop members is illustrated on the bottom portion of the FIG. 1 as 186. The overlapping of both the flexible member is similar to the width 186 of the fabric hinge between them. The bottom part of FIG. 1 illustrates minimum width possible by overlapping of both the flexible member as 180.

The maximum coverage width 185 and minimum width possible 180 by fully overlapping of both the flexible members can be used to provide compatibility information to a given window. A guidance method can be established wherein the compatibility is based on the fully extension of the sunshade configuration 100, partial or full overlapping of both the flexible members. This compatibility method can help recommend sunshade configuration 100 to a variety of widths of window dimensions or widths. The sunshade configuration 100 can adopt any of the flexible member shape or configuration shown FIGS. 3 to 7, FIG. 10 and FIG. 11. The sunshade 100 configuration can have a size recommendation based on wherein the both loop members' (with fabric) dimensions being similar to adoptable to the dimensions of a window. In recommendation of the sunshade configuration 100 for an automobile, one loop member can accommodate driver-side windshield and another loop member can accommodate passenger side windshield window.

The sunshade configuration 100 is shown fully extended on the top of FIG. 1; wherein the total width of the coverage area 185 is a total width of the fabric with having fabric-hinge that is 186 wide. The bottom part of the FIG. 1 illustrates the same sunshade configuration wherein both the flexible members 110 are overlapped with a minimum possible width shown as 186. The amount of overlapping of the two loop members is illustrated on the bottom portion of the FIG. 1 as 181. The overlapping portion width 181 is substantially directly related to the width of the fabric-hinge 186. The bottom part of FIG. 1 illustrates minimum width possible by overlapping of both the flexible member as 180.

The maximum coverage width 185 and minimum width possible 180 by fully overlapping of both the flexible members can be used to provide compatibility information to a given window. A guidance method can be established wherein the compatibility is based on the fully extension of the sunshade configuration 100, partial or full overlapping of both the flexible members. This compatibility method can help recommend sunshade configuration 100 to a variety of widths of window dimensions or widths.

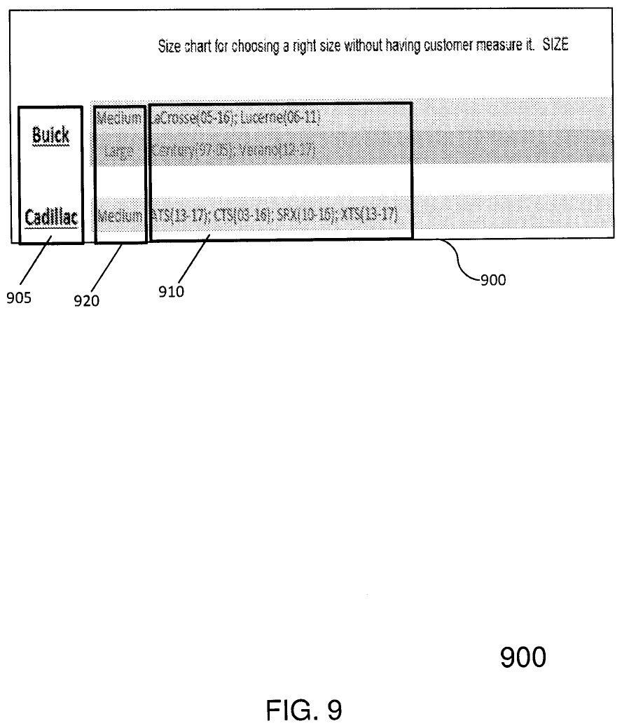

FIG. 9 illustrates sunshade compatibility guidance method wherein the illustrated size-chart has make 905, model 910 with model year range in the brackets and a compatible size 920 in size chart 900. This size-chart can be illustrated online or on packaging wherein the consumer can identify year make and model of their vehicle and find correspond size for it wherein the consumer does not need to measure the windshield glass prior to the purchase because the seller already has measured various windshield and have configured the compatibility guidance information 900 for the end-customer.

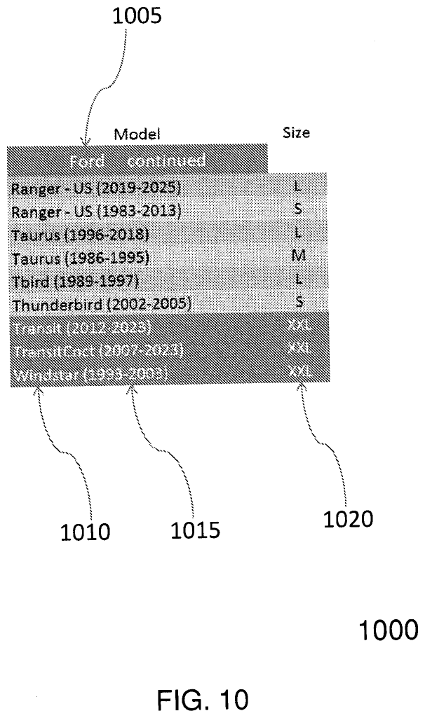

FIG. 10 illustrates sunshade compatibility guidance method wherein the maker of a vehicle in section 1005 with vehicle models 1010 listed with year range 1015 wherein a compatible sunshade sizes are illustrated in section 1020. In this configuration of guidance method the customer can find multiple or all vehicle models for each make under one section which eliminates need of finding a vehicle model in multiple sections. Each of the two loop members in every embodiment are made from flexible steel wire or similar material thus the loop member can be squeezed vertically to fit shorter windshield and/or squeezed sideways (on vertical sides) to make it fir in narrower window. Each of the two loop members maximum and minimum possible compressed height; combined with maximum and minimum possible compressed width can be used to provide compatibility guidance for a given size to a window or an automobile window. Also, compatibility of a given sunshade can be recommended to windows upto 2 inches taller and upto 4 inches shorter in height than the height of the two loop members in sunshade configuration 100 or 200. Compatibility of a given sunshade can be recommended for windows with upto 8 inches shorter in width than overlapped minimum width of a sunshade configurations 100 or 200's two flexible loop members; and for windows upto 4 inches wider than the extended (maximum) width possible of sunshade configurations 100 or 200's two loop members width. A sunshade compatibility method can also include a drop down menu on a website wherein the customer can choose year make and model of at least one vehicle wherein the customer is provided compatibility information of the given size of sunshade configuration 100 or 200. The guidance method for sunshade configurations 100, 200 and 1200 wherein each of the loop member has two horizontal sides and two vertical sides. The distance between two horizontal sides is the height of the loop member wherein the combined distance between two outside vertical sides of both loop members has maximum and minimum combined width of the two loop members. The guidance method for sunshade configurations 100, 200 and 1200 also can be based upon the distance between two horizontal sides of each of the loop member being upto 3 inches taller/shorter in height of the window its being recommended for.

FIG. 11 illustrates a sunshade with a loop members 1105 installed inside a vehicle window 1110. A compatibility guidance method can be established wherein the compatibility of sunshade is based on the height of the flexible member 1105 similar to the height of the window 1310 it's being recommended for. The compatibility method also can be based on the adjustable width of the sunshade configurations 100 and/or 200 by partial overlapping and/or extension of the both the flexible members as shown in FIG. 1 and FIG. 8. In this guidance method, both the circles are partially overlapped to fit various width windows. By using this compatibility guidance method for this sunshade; one size can be recommended for various widths of windows. The size-guidance for this automotive interior sunshade also can be based upon the height of the flexible member being similar to the height of the window. An automobile interior window sunshade comprising at least one loop member sewed on at least one fabric and compatibility information can be provided wherein different compatible sizes are listed in the same size-chart to provide best coverage possible for any given automobile model.

A guidance method also can be based on the height of the flexible members. The flexible member also can be overlapped to achieve coverage for variety of widths. A guidance method also can be based upon the sunshade's ability to cover various dimensions that provides coverage to the various dimensions of windows. The guidance also can be based on the top and bottom portion of the flexible member which is substantially straight and/or arched wherein the distance between top and bottom loop member sides is substantially identical to the height of the window/windshield. A guidance method can be established wherein a sunshade size can be offered for sale which can fit multiple dimensions of windows, providing a size compatibility information to the customer, offering the customer sunshade size/s, allowing the customer to select a correct size for the given vehicle, wherein the vehicle information can include year make and model of the vehicle wherein multiple models from the same make is under one section wherein at least two models of the same make takes two different sunshade sizes. The size guidance method also can include the following steps: 1) providing customer a drop down menu to select year make and model, 2) displaying a compatibility of sunshade sizes for the selected vehicle, wherein the sunshade size is compatible with variety of window dimensions, 3) providing the customer an option to select a correct size. The sunshade also can have a loop member with configuration 100 or 200 that is compressible to adjust vertical height and/or horizontal width of at least two window dimensions.

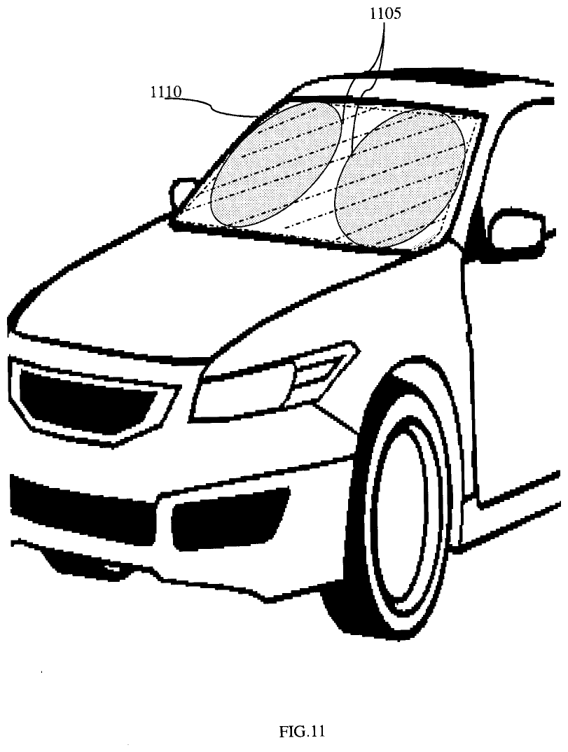

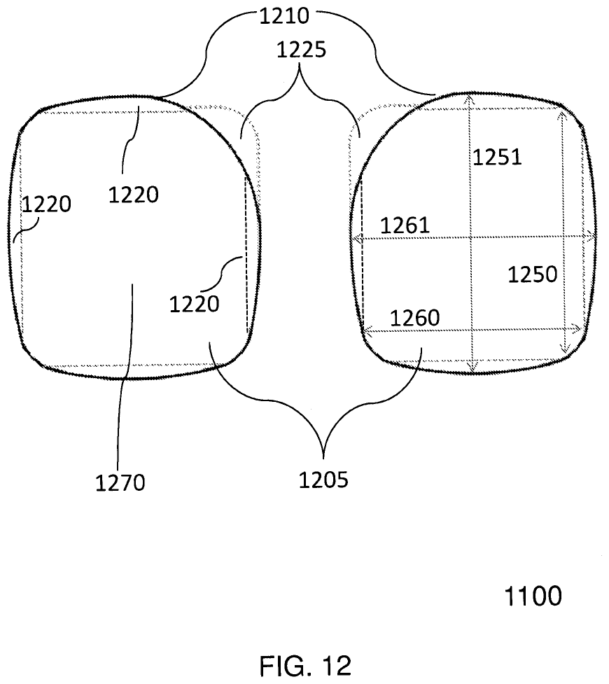

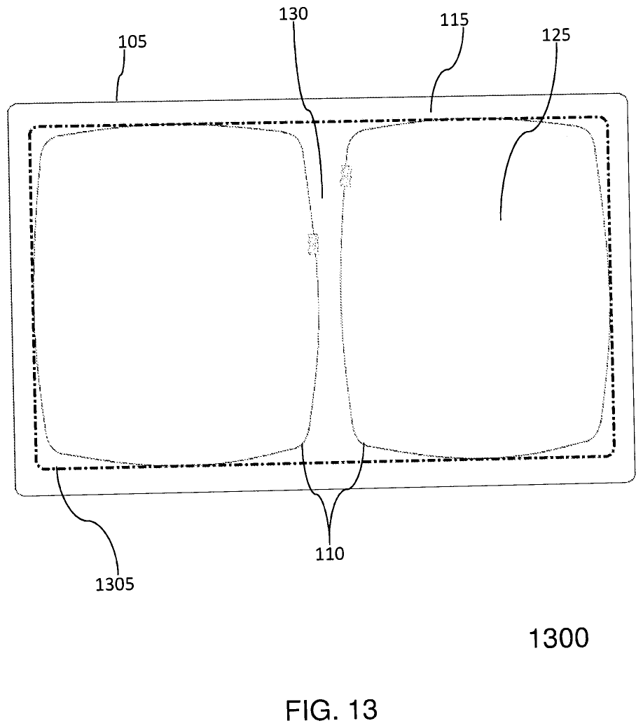

FIG. 12 illustrates another embodiment of sunshade 1200 wherein each of the two loop member 1210 is sewed on fabric 1205 wherein in this configuration a loose fabric outside of each of the two loop member is absent. The fabric inside each of the two loop members is erected with help of both the flexible members 1210. Each of the two loop members has a bypass-bend 1225 for hassle-free installation inside an automobile windshield with a rear view mirror in the center. Each of the two loop members has an easy-flex-arch on the top side 1220, bottom side 1265, outer side 1250 and inner side 1255. Each of the flexible members can have maximum height of 1251 and minimum height of 1250 with both top 1220 and bottom 1265 easy-flex-arches squeezed. Each of the two loop members can have a maximum width of 1251 and minimum height of 1250 with both side 1220 & 1265 easy-flex-arches squeezed. A guidance method can be established wherein the compatible vehicle windows can be recommended based on having a window's minimum height upto 3″ shorter than the minimum height 1250 and maximum height of the window being upto 3″ taller than of each of the two loop members 1251. An interior windows can be recommended based on having a window's minimum width upto 3″ narrower than the minimum width 1260 and maximum width of the window being upto 3″ wider than of each of the two loop members 1261. This embodiment with two loop members 1210 also can be conjoined (not shown) with a fabric hinge between them while having no other loose fabric on top, bottom or outer side of the each of the two loop members. FIG. 13 illustrates the fabric 105 with each of the two flexible loop members 110 comprising four easy-easy-flex-arches 320 on each of its four sides installed inside a building window 1305. The interior window sunshade shown in FIG. 13 further has a loose fabric border 115 on 3 outer sides of each of the two flexible loop members 110. Both the two flexible loop members have an inside erect fabric 125 and a fabric-hinge 130.

The sunshade configurations 100 and 200 also can be customized to be used with any kind of window to block the sun light including house windows and automobile windows. The fabric of the sunshade can be secured by sewing a one side of Velcro on the sunshade and sticking other piece of the Velcro on the window it's being placed against to provide better coverage. The guidance chart shown in the FIGS. 9-11, wherein the compatibility guidance is provided for a given sunshade's loop member's height being substantially similar to the height of the vehicle's windshield glass. The fabric between two loop members allows extended coverage wherein the extra fabric also provides material needed to overlap both the flexible member to fit a narrow width windshield glass of a vehicle. The compatibility guidance provided in this invention can be based on minimum and maximum coverage area of the sunshade by overlapping or extension of the two loop members. In 2 pc sunshade designs wherein two pieces are separate can be overlapped to one another partially and the compatibility recommendation will be based on smallest width of the windshield the shade can fit by overlapping of the two separate sunshade pieces to the widest vehicle windshield by extension of both the flexible members of two separate pieces. The height of each of the two loop members in every guidance method needs to be substantially similar to the height of the windshield it is being recommended for.

The fabric-hinge is a fabric portion between the two flexible loop members in a sunshade embodiments that has a two flexible loop members sewed on a same fabric. The width of the hinge can be varying from being 3 inches between two loop members to as much as 14 inches between two loop members. The height of the flexible member also can vary from being as small as 14 inch taller to as tall as 42 inches taller. The width of the flexible member can be from 20 inches in width to 34 inches in width. To make a sunshade for a window that is 55 inches wide; the flexible member can be 24 to 27 inches wide with allowing 4-6 inches of fabric between the two flexible loop members. The same sunshade also helps in providing coverage to the window as wide as 52 inches (24+24+4) to 61 inches (27+27+7). The width of the fabric-hinge allows versatility for a same shade to fit various width windows. For a wider window, a sunshade can be configured to have 27 to 30 inches in width with 6 to 10 inches of fabric between the two flexible loop members. This configuration will be able to cover window widths from 60 inches (27+27+6) to as wide as 70 inches (30+30+10) by overlapping of both the flexible loop member using the fabric-hinge. If the fabric-hinge (distance between the two flexible loop members) is 4 to 5 inches; it will provide sufficient coverage for windshields that varies 4-5 inches in width by overlapping the two flexible loop members with help of 4 to 5 inches wide fabric-hinge. If the fabric-hinge (distance between the two flexible loop members) is 6 to 7 inches; it will provide sufficient coverage for windshields that varies 6 to 7 inches in width by overlapping the two flexible loop members with help of 6 to 7 inches wide fabric-hinge. If the fabric-hinge (distance between the two flexible loop members) is 8-9 inches; it will provide sufficient coverage for windshields that varies 8-9 inches in width by overlapping the two flexible loop members with help of 8-9 inch wide fabric-hinge. If the fabric-hinge (distance between the two flexible loop members) is 10-11 inches; it will provide sufficient coverage for windshields that varies 10-11 inches in width by overlapping the two flexible loop members with help of 10-11 inches wide fabric-hinge. If the fabric-hinge (distance between the two flexible loop members) is 12-14 inches; it will provide sufficient coverage for windshields that varies 12-14 inches in width by overlapping the two flexible loop members with help of 12-14 inches wide fabric-hinge.

All the embodiments with two flexible loop members sewed on a same fabric can have a loop member height of 28-31 inches can have 3-9 inches of fabric-hinge. Additionally, all the embodiments with two flexible loop members sewed on a same fabric can have a loop member with a height of 24-28 inches can have 3-10 inches of fabric-hinge. All the embodiments with two flexible loop members sewed on a same fabric can have a loop member with a height of 15-24 inches can have 3-9 inches of fabric-hinge. All the embodiments with two flexible loop members sewed on a same fabric can have a loop member with a height of 31-39 inches can have 3-9 inches of fabric-hinge.

For embodiments with only one flexible loop member sewed on a fabric can overlap and extend without any limitations such as the ones in the embodiments with two loop members sewed on the same fabric. These embodiments can have a border absent outside of the one flexible loop member wherein the loose fabric outside of the flexible member is not present. Embodiments with the one flexible loop member sewed on fabric; can have at least one of the following to make the design feasible to be used as universal sunshade that fits various vehicles with reasonable variations in the window dimensions. The sunshade comprising at least one of the following: 1) the one loop member having at least one easy-flex-arch; 2) at least one bypass-bend. Additionally the one loop member sunshade can have a Velcro to connect the one piece to the sunshade piece once installed. The embodiments with bypass-bend feature, the bypass-bend is a corner of the at least one flexible loop member wherein the corner is significantly greater in length compared to rest of the corners.

For embodiments wherein two flexible loop members sewed on the same fabric can only be made feasible to be used as a universal sunshade to a variety of window dimensions is by having at least 4 to 14 inches of fabric-hinge between two loop members, wherein each of the two loop members comprising at least one of the following: 1) the flexible members having at least one easy-flex-arch; 2) at least one bypass-bend. Additionally the sunshade can have a cut-out with a securing mechanism on the top to secure fabrics from each side of the flexible member with one another. The securing mechanism can be one of Velcro, magnetic tape or suction cups. The sunshade also can have the cut-out absent and still have the securing mechanism that secures the fabrics on the top of the obstacle to one another.

Additionally, some of the embodiments can have the flexible loop member can have a bypass-bend in at least one corner with at least three substantially straight and/or at least two easy-flex-arch sides. The flexible member can have slightly arched side at least on top and/or bottom and/or outer vertical side that stays flushed with the A-pillar of an automotive vehicle. By having a slightly arched horizontal side on top and/or bottom sides; the flexible members can flex. To use one side of sunshade embodiments with the two loop members sewed on the same fabric, each of the two loop members can have the easy-flex-arch feature on the one of both the vertical sides to allow maximum variability fitment to fit windshields that varies in widths. This similar issue also can be addressed by having 4-14 inches wider fabric-hinge between the two flexible loop members. By having one or both horizontal sides of the sunshade with one/two flexible loop members can fit windshields that varies in height. A Sunshade configuration also can have at least one easy-flex-arch on each of the flexible members' on vertical side to allow horizontal adjustability; at least one easy-flex-arch feature on each of the flexible members' horizontal side to allow vertical flexibility to provide fitment to windows that varies in height and width. Additionally almost all of the sunshade embodiments can have a bottom side of the fabric wider than the top sides to allow better fitment in vehicle with a sloped windows which is wider at the bottom than the top of the window. In this configuration the flexible member may have four sides but not parallel to one another to form a rectangular shape. The fabric also may follow the shape of the flexible members and have a fabric that has four sides wherein two vertical sides straight while top and bottom sides being curved to match the shape of an automobile window. The easy-flex-arch shown in various embodiments is a flexible arch of a loop member that provides additional flexibility.

The easy-flex-arch can be arched as much as upto 10 inches from straight line between two adjacent corners. So the total height between two opposite arched peak points would be 20 inches more than the distance between adjacent corners of the easy-flex-arches opposite to one another. In other words the loop member can be as tall as 25 inches in height between two corners but with easy-flex-arch being as tall as upto 10 inches; it can add another 20 inches for two easy-flex-arches (one on top+one on the bottom)=45 inches. Ideally the arch can deviate 0-5 inches from the straight (imaginary) line between two adjacent corners. The above easy-flex-arch configuration can be used in the sunshade configuration 100; 200 and/or 1200. The loose fabric border outside of the loop members in sunshade configuration 100 and 200 can have fabric border upto 5 inches outside of the loop members. A compatibility of the sunshade configurations 100, 200 and 1200 can be based on the followings:
1) Relaxed vertical height between two horizontal sides of each of the two flexible loop members while the loop members are not under any external force;
2) Compressed vertical height between two horizontal sizes of each of the two flexible loop members wherein the at least one easy-flex-arch of the loop members is vertically compressed upto 5 inches from its relaxed height;
3) extended width of the fabric of the sunshade configuration 100 and 1200 wherein the width is from one vertical side of fabric to another vertical side of the fabric; extended width of the sunshade configuration 200 and 1200 with each of the loop members are sewed on a separate fabric wherein both the loop members are placed next to one another to provide continuous blocking coverage to the window;
4) overlapped width, wherein each of the two loop members are overlapped using fabric hinge in sunshade configurations 100 and 1200; maximum overlapping possible for a sunshade configurations 200 and 1200 wherein each of the two loop members are sewed on a separate fabrics and are overlapped to minimum width possible; wherein for the sunshade configurations with at least one easy-flex-arch on vertical side of each of the loop members; the overlapped width will be minimum width with all easy-flex-arch compressed.

A compatibility guidance method can be established using steps 1 to 4 wherein the recommended having upto 5 inches taller or shorter vertical height than the relaxed loop member and/or width of upto 20 inches shorter from extended width of the fabric. The compatible sunshade will have each of the two loop members horizontal sides; wherein the bottom horizontal side stays flushed to the lowered part of the windshield glass where the windshield meets the dashboard & the top horizontal side should be substantially close or compressed against the headliner or the sun visor of the vehicle. The maximum width of the windows should have one vertical side of a fabric (in sunshade configuration with fabric hinge) substantially closer to the A pillar of a vehicle on driver side and another side of the fabric closer to the A pillar on the passenger side. For sunshade configurations wherein each of the two loop members are sewed on separate fabrics, the two outer vertical sides of combined two pieces should be substantially as wide as the width of the windshield between two A pillars of a vehicle. For a sunshade with one loop member on one fabric, a compatible window recommended can be substantially closer to relaxed—compressed height/width of the one loop member.

The compatibility guidance can include a size-chart on product packaging and/or on a webpage, wherein the size chart identifies at least two year make and models of the vehicle with compatible size for the identified vehicle, wherein at least two identified vehicle takes a different size sunshades. The compatibility information also can be given to the customer online by use of a drop down menu on a website to select a window or year make and model of the vehicle; wherein the website populated the compatible size chart for the vehicle.

The present invention relates to sunshades with a clamping mechanism. More specifically The sun shades for protecting the interior of vehicles against the harmful effects of prolonged exposure to the sun.

As shown in FIG. 13, the device zig-zag clamping device includes at least one flexible loop member 8 and 9 having a first endpoint 22 and a second endpoint 23. Further, the clamping device 10 includes a hollow enclosure made by a zig-zag shaped first side wall 16 and a zig-zag shaped second side wall 17, a top surface 21 and a bottom surface 15, a front wall 18 having a first inlet section for securely receiving the first endpoint 22 of the flexible loop member 8 or 9 and an rear wall 19 having a second inlet section for receiving the second endpoint 23 of the flexible loops member 8 or 9, wherein the hollow enclosure is adapted to connect the first endpoint 22 and the second endpoint 23 of the flexible loop member in tight and securely manner.

In another embodiment of the present invention, the zig-zag shaped first side walls 16 and second wall 17 are adapted to bend slightly inside the hollow enclosure whenever received an external force is applied on pressing points 26, 27, 28, and 29 (as shown in FIG. 13) located off set on the zig-zag shaped first side walls. And as result of the external force, the zig-zag shaped first side walls 16 and second wall 17 are adapted to bend the first endpoint 22 and second endpoint 23 in zig-zag shape inside the hollow enclosure for creating a tight grip. The first endpoint 22 includes a first partial portion of the flexible loop member 8 or 9 connected to the first endpoint 22, which is inserted along with the first endpoint 22 into the hollow enclosure through the first inlet section located at front wall 18. Similarly, the second endpoint 23 includes a second partial portion of the flexible loop member 9 or 8 connected to the second endpoint 23, which is inserted along with the second endpoint into the hollow enclosure through the first inlet section located at rear wall 19.

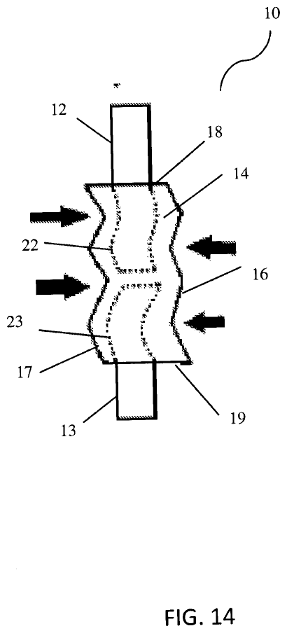

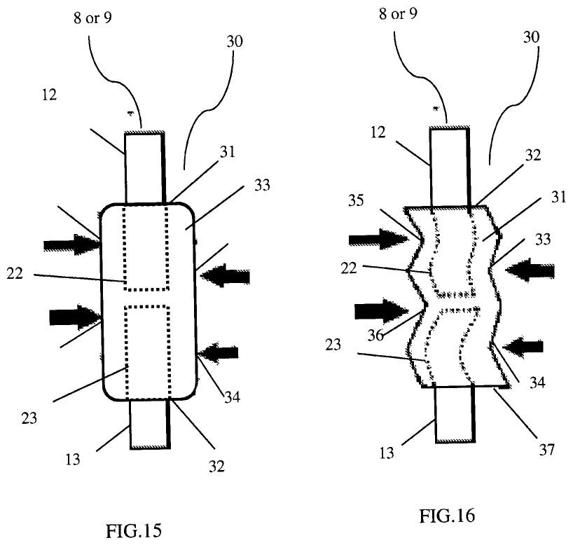

FIG. 14 and FIG. 15 show another embodiment of the present invention, the FIGS. 14 illustrate a flexible loop member clamped in a zig-zag manner by a clamping device 30. The clamping device 30 includes a hollow enclosure sleeve 31 includes a front opening 32 for receiving the first end point 12 of the flexible loop member 8 or 9 and a rear opening for receiving second end point 13 of the flexible loop member 8 or 9. The hollow enclosure sleeve 31 is made of metal. The hollow enclosure sleeve 30 includes opposite pressing points 33, 34, 35 and 36 placed offset to one another, wherein the hollow enclosure sleeve 30 being pressed at the opposite pressing points 33, 34, 35 and 36 resulting in a Zig-Zag structure formation at opposite pressing points 33, 34, 35 and 36 and bends the first endpoint 12 and second endpoint 13 in a zig-zag manner within the hollow enclosure sleeve as shown in FIG. 15. The hollow enclosure sleeve 30 is adapted to connect the first endpoint and the second endpoint of the flexible loop member in a tight and secure manner.

What is claimed is:

1. An interior window sunshade comprising:
two flexible steel flat wire loop members, a fabric-hinge and a fabric, wherein the fabric is sewed on each of the two flexible steel flat wire loop members, wherein each of the two flexible steel flat wire loop members consist of a flexible steel flat wire and the hollow enclosure; the flexible steel flat wire having two wire width sides and two wire thickness sides, wherein each of the two wire width sides is greater than each of the two wire thickness sides;
the hollow enclosure having two enclosure width sides and two enclosure thickness sides, wherein each of the two enclosure width sides is greater than each of the two enclosure thickness sides;
wherein the hollow enclosure accommodates a first end point and a second end point of the flexible steel flat wire within, wherein the hollow enclosure is pressed in to form bends in the hollow enclosure, wherein at least one of the pressing points presses in against only one of the two enclosure width sides, wherein the hollow enclosure is configured to secure each of the first end point and the second end point of the flexible steel flat wire to the hollow enclosure independently without overlapping of the first end point and the second end point to one another to form the at least two flexible steel flat wire loop members;
wherein each of the two flexible steel flat wire loop members has at least 4 corners and at least 4 sides; wherein each of the two flexible steel flat wire loop members comprises the following:
at least two flexible arches with a single bypass-bend, wherein each of the at least two flexible arches is an outward arched side of the at least 4 sides between two adjacent corners of the at least 4 corners, wherein a first of the at least two flexible arches is substantially horizontal lower side of the at least 4 sides of each of the two flexible steel flat wire loop members;
wherein a second of the at least two flexible arches is a second side of the at least 4 sides, wherein the second side is directly connected to the first side via a first corner of the at least 4 corners;
wherein a third side of the at least 4 sides is directly connected to the second side directly via the single bypass-bend, wherein the single bypass-bend directly connects the second side to the third side, wherein the single bypass-bend is an upper interior corner of the at last 4 corners that is configured to bypass an obstruction that is present between the two flexible steel flat wire loop members, wherein the single bypass-bend is a second corner of the at least 4 corners;
wherein the third side is directly connected to a fourth side of the at least 4 sides via a third corner of the at least 4 corners, wherein the fourth side is a substantially vertical outer side and directly connected to the first side via a fourth corner of the at least 4 corners;
wherein the fabric-hinge is a connecting fabric between each of the second sides of the two flexible steel flat wire loop members, wherein the fabric-hinge is 3-14 inches wide, wherein the fabric-hinge is between the two flexible loop steel flat wire members, wherein the width of the fabric-hinge excludes any permanent or detachable additional flexible loop member, wherein the fabric-hinge provides fitment to a wider range of interior window dimensions, wherein each of the two flexible steel flat wire loop members has only one of the single bypass-bend;
wherein the interior window sunshade further has a fabric border, wherein the fabric border is on a top side of the at least 4 sides, a bottom side of the at least 4 sides and an outer side of the at least 4 sides of each of the two flexible steel flat wire loop members.

2. The interior window sunshade claimed in claim 1, wherein the interior window sunshade is configured to be compatible with an automobile window or a building window.

3. The interior window sunshade claimed in claim 1 comprising: a total of at least three flexible arches on each of the two flexible steel flat wire loop members, wherein each of the first side, the second side and the third side of each of the two flexible steel flat wire loop members is formed by respective ones of the at least three flexible arches.

4. The interior window sunshade claimed in claim 1, wherein the fabric is semi-transparent or capable of substantially blocking sun-light.

5. The interior window sunshade claimed in claim 1, wherein only one of the fabric comprises the fabric-hinge and fabric borders, and the fabric holds each of the flexible loop members two flexible steel flat wire loop members.

6. (canceled)

7. The interior window sunshade claimed in claim 1, wherein each of the two flexible steel flat wire loop members is configured to have a height and/or width and/or dimensions being up to 3 inches smaller or larger than a window.

8. An interior window sunshade comprising:
two flexible steel flat wire loop members, wherein each of the two flexible steel flat wire loop members has at least 4 corners and at least 4 sides; wherein each of the two flexible steel flat wire loop members featuring the following:
at least two flexible arches with a single bypass-bend, wherein each of the at least two flexible arches is an outward arched side of the at least 4 sides between two adjacent corners of the at least 4 corners, wherein a first of the at least two flexible arches is substantially horizontal lower side of the at least 4 sides of each of the two flexible steel flat wire loop members;
wherein a second of the at least two flexible arches is a second side of the at least 4 sides, wherein the second side is directly connected to the first side via first corner of the at least 4 corners;
wherein a third side is directly connected to the second side directly via the single bypass-bend, wherein the single bypass-bend directly connects the second side to the third side, wherein the single bypass-bend is a second corner of the at least 4 corners that is configured to bypass an obstruction that is present between the two flexible steel flat wire loop members;
wherein the third side is directly connected to a fourth side of the at least 4 sides via a third corner of the at least 4 corners, wherein the fourth side is substantially vertical outer side and directly connected to the first side via a fourth corner of the at least 4 corners;
and;
a fabric,
wherein one piece of said fabric is sewed on one of the two flexible steel flat wire loop members, wherein each one piece of the fabric with one of the two flexible steel flat wire loop members forms one piece of sunshade, wherein each of the two flexible steel flat wire loop members is sewed on two separate pieces of the fabric, resulting in a 2 piece interior window sunshade to be used together.

9. The interior window sunshade claimed in claim 8, wherein the interior window sunshade is configured to be compatible with an automobile window or a building window.

10. (withdrawn, currently amended) The interior window sunshade claimed in claim 8, the interior window sunshade comprising the at least four flexible arches or the at least one flexible arch with the single bypass-bend, comprising a loose fabric border, wherein each of the 2-piece interior window sunshade further comprises a loose border surround an outer perimeter of each of the two flexible steel flat wire loop members, wherein the loose fabric border extends up to 5 inches surrounding to each of the two flexible steel flat wire loop members.

11. The interior window sunshade claimed in claim 8, wherein the fabric sewed is semi-transparent and/or capable of substantially blocking sunlight.

12. The interior window sunshade claimed in the claim 8, the interior window sunshade comprising the at least four flexible arches, comprising a loose fabric border, wherein each of the two flexible steel flat wire loop members comprises the at least 4 sides and the at least 4 corners, wherein each of the at least 4 sides comprises one of the four flexible arches or one of the at least one flexible arch, wherein the interior window sunshade further comprises a loose fabric border, wherein the loose fabric border extends up to 5 inches surrounding to the each of the two flexible steel flat wire loop members.

13. The interior window sunshade claimed in the claim 8, the interior window sunshade comprises the at least one flexible arch with the single bypass-bend, comprises a loose fabric border, wherein each of the 2-piece interior window sunshade has an additional loose fabric border surrounding to each of the two flexible steel flat wire loop members that extends up to 5 inches on top and/or bottom and/or an outer side of each of the two flexible loop.

14. The interior window sunshade claimed in claim 8, wherein each of the two flexible steel flat wire loop members configured to have a height and/or dimensions being up to 3 inches smaller/larger than a window.

15. (canceled)

16. (canceled)

17. (canceled)

18. (canceled)

19. (canceled)

20. An interior window sunshade comprising:
two flexible steel flat wire loop members, a fabric-hinge and a fabric, wherein the fabric is substantially rectangular and is sewed on each of the two flexible steel flat wire loop members, wherein each of the two flexible steel flat wire loop members has at least 4 corners and at least 4 sides; wherein each of the two flexible steel flat wire loop members consist of a flexible steel flat wire and the hollow enclosure; the flexible steel flat wire having two wire width sides and two wire thickness sides, wherein each of the two wire width sides is greater than each of the two wire thickness sides;
the hollow enclosure having two enclosure width sides and two enclosure thickness sides, wherein each of the two enclosure width sides is greater than each of the two enclosure thickness sides;
wherein the hollow enclosure accommodates a first end point and a second end point of the flexible steel flat wire within, wherein the hollow enclosure is pressed in to form bends in the hollow enclosure, wherein at least one of the pressing points presses in against only one of the two enclosure width sides, wherein the hollow enclosure is configured to secure each of the first end point and the second end point of the flexible steel flat wire to the hollow enclosure independently without overlapping of the first end point and the second end point to one another to form the at least two flexible steel flat wire loop members;
wherein each of the two flexible steel flat wire loop members comprises:
at least three flexible arches with only two bypass-bends, wherein each of the at least three flexible arches is an outward arched side of the at least 4 sides between two adjacent corners of the at least 4 corners, wherein a first of the at least three flexible arches is a substantially horizontal lower side of the at least 4 sides of each of the two flexible steel flat wire loop members;
wherein a second of the at least three flexible arches is a second side of the at least 4 sides, wherein the second side is directly connected to the first side via a first bypass-bend of the only two bypass-bends, wherein the first bypass-bend is a lower interior corner that is configured to bypass an obstruction that is present between the two flexible steel flat wire loop members, wherein the first bypass-bend is a first corner of the at least 4 corners;
wherein a third of the at least three flexible arches is a third side of the at least 4 sides, wherein the third side is directly connected to the second side via a second bypass-bend of the only two bypass-bends, wherein the second bypass-bend directly connects the second side to the third side, wherein the second bypass-bend is an upper interior corner that is configured to bypass an obstruction that is present between the two flexible steel flat wire loop members, wherein the second bypass-bend is a second corner of the at least 4 corners;
wherein the third side is directly connected to a fourth side of the at least 4 sides via a third corner of the at least 4 corners, wherein the fourth side is a substantially vertical outer side and directly connected to the first side via a fourth corner of the at least 4 corners;
wherein the fabric-hinge is a connecting fabric between each of the second sides and the only two bypass-bends of each of the two flexible steel flat wire loop members, wherein the fabric-hinge is 3-14 inches wide, wherein the fabric-hinge is between the two flexible steel flat wire loop members, wherein the width of the fabric-hinge excludes any permanent or detachable additional flexible loop member, wherein the fabric-hinge provides fitment to a wider range of interior window dimensions;
wherein the interior window sunshade further has a fabric border, wherein the fabric border is on a top side of the at least 4 sides, a bottom side of the at least 4 sides and an outer side of the at least 4 sides of each of the two flexible steel flat wire loop members.

21. The interior window sunshade claimed in claim 20, wherein the interior window sunshade is configured to be compatible with an automobile window or a building window.

22. The interior window sunshade claimed in claim 20 comprising: a total of at least four flexible arches on each of the two flexible steel flat wire loop members, wherein each of the first side, the second side, the third side and the fourth side of each of the two flexible steel flat wire loop members is formed by respective ones of the at least one three flexible arches.

23. The interior window sunshade claimed in claim 20, wherein the fabric is semi-transparent or capable of substantially blocking sun-light.

24. The interior window sunshade claimed in claim 20, wherein one of the fabric comprises the fabric-hinge and fabric borders, and the fabric holds each of the flexible loop members two flexible steel flat wire loop members.

25. The interior window sunshade claimed in claim 20, wherein the fourth side of each of the at least two flexible steel flat wire loop members is substantially straight.
